(19) United States
(12) Patent Application Publication
(10) Pub. No.: US 2011/0020496 A1
(43) Pub. Date: Jan. 27, 2011

(54) BRANCHED DEXTRIN, PROCESS FOR PRODUCTION THEREOF, AND FOOD OR BEVERAGE

(75) Inventors: Kensaku Shimada, Itami-shi (JP); Yuko Uehara, Itami-shi (JP); Yuko Yoshikawa, Itami-shi (JP); Isao Matsuda, Itami-shi (JP); Takako Yamada, Itami-shi (JP)

Correspondence Address: SUGHRUE MION, PLLC, 2100 PENNSYLVANIA AVENUE, N.W., SUITE 800, WASHINGTON, DC, 20037, US

(73) Assignee: Matsutani Chemical Industry Co., Ltd., Itami-shi, Hyogo (JP)

(21) Appl. No.: 12/922,648

(22) PCT Filed: Mar. 13, 2009
(86) PCT No.: PCT/JP2009/054852

§ 371 Date: Sep. 14, 2010

(30) Foreign Application Priority Data
Mar. 14, 2008 (JP) 2008-065677
Jul. 25, 2008 (JP) 2008-192691

(51) Int. Cl. A23L 1/09; A23L 2/60; A23L 1/30; C08B 30/18

(52) U.S. Cl. 426/48; 426/590; 426/648; 426/658; 536/46

(57) ABSTRACT

A branched dextrin insusceptible to digestion and having a low osmotic pressure, as well as a method for producing such a branched dextrin is provided. The branched dextrin characterized by having a structure wherein glucose or isomalto oligosaccharide is linked to a non-reducing terminal of a dextrin through an α-1,6 glucosidic bond and having a DE of 10 to 52. A method characterized in that, in a method for producing a branched dextrin by allowing maltose-generating amylase and transglucosidase to act on an aqueous dextrin solution, the maltose-generating amylase and transglucosidase are adjusted so as to attain an enzyme unit ratio of 2:1 to 44:1 and allowed to act.

### TECHNICAL FIELD

The present invention relates to a branched dextrin which is insusceptible to digestion and, in addition, has a low osmotic pressure, as well as a method for producing such a branched dextrin. The present invention also relates to food products and beverages, and nutritional supplement products containing the branched dextrin obtained by this method.

### BACKGROUND ART

It has been known that the number of diabetic patients is increasing in recent years. Diabetes is a disease in which action or production of insulin decreases and thus the diabetic patients are, when taking in saccharides, not able to control an increase in blood glucose concentration, that is, hyperglycemia. Since sustained hyperglycemia adversely affects a human body, there is a need for saccharides used in nutritional supplement products for the diabetic patient, which are insusceptible to digestion and control a rise in blood glucose values. In addition, there is a need for the saccharides used in the nutritional supplement products, with a lower osmotic pressure such as dextrin obtained by hydrolyzing starch with an acid or enzyme, since glucose, sugars or the like have a higher osmotic pressure and trigger osmotic diarrhea. Therefore, for the diabetic patients, development of saccharides insusceptible to digestion and, in addition, having a low osmotic pressure is extremely useful. Further, the saccharides insusceptible to digestion and having the low osmotic pressure can also be used as saccharide sources in diet food, energy supplying drinks, nutritional supplement products and the like. Hence, the development thereof is extremely significant.

Dextrins are, with glucose as a constituting unit, composed of a component forming a linear structure of α-1,4 glucosidic bonds and a component forming a branched structure containing α-1,6 glucosidic bonds. Among them, the branched structure containing α-1,6 glucosidic bonds is a structure insusceptible to digestion (decomposition) by digestive enzymes such as amylases. Because of this, the so-called branched dextrin with a higher percentage of this branched structure is insusceptible to digestion, which has been clarified/proven by studies thus far (Patent Documents 1, 2, 3 and 4, and Non-patent Document 1).

In those studies, methods for producing the branched dextrin aiming at obtaining a dextrin insusceptible to digestion are roughly classified into two methods. That is, those are “a method for obtaining a branched dextrin by separating and collecting a component with starch intrinsic branched structures” and “a method for obtaining a branched dextrin by synthesizing α-1,6 glucosidic bonds by an enzymatic transfer reaction.”

In “a method for obtaining a branched dextrin by separating and collecting a component with starch intrinsic branched structures”, for instance, a method for producing a highly branched dextrin (Patent Document 1) is known, the method being characterized by decomposing starch by α-amylase or an acid, decomposing further this decomposition product by β-amylase or a mixture of α-amylase and β-amylase, and collecting the highly branched dextrin with a high percentage of α-1,6 glucosidic bonds. However, the yield of the highly branched dextrin obtained by this method of production was only about 20%. Thus, the method is less than an efficient method of production.

Meanwhile, in “a method for obtaining a branched dextrin by synthesizing α-1,6 glucosidic bonds by an enzymatic transfer reaction”, a method using a branching enzyme and a method using α-glucosidase are known.

As the former method using a branching enzyme, for instance, a method for producing a branched dextrin characterized by allowing the branching enzyme to act on dextrins, successively allowing β-amylase to act on the mixture and separating the resultant to collect a high molecular weight fraction (Patent Document 2) is known. However, operations in this method of production are complicated. The method is thus less than an efficient method of production.

As the latter method using α-glucosidase, for instance, a method for generating branched oligosaccharides by heating at least 70% by weight dextrin solution to at least 40° C. and allowing an enzyme, including α-glucosidase, which promotes cleavage or generation of glucosidic bonds, to act on the dextrin solution (Patent Document 3) is known. But the substrate concentration is limited to 70% by weight or more in this method. Further, the osmotic pressure of the generated branched oligosaccharides was high and thus there are some cases where use of the branched oligosaccharides to nutritional supplement products with no modification is restricted.

Also, for instance, a method for producing branched starch (Non-patent Document 1) characterized in that β-amylase and one type of α-glucosidase, transglucosidase are simultaneously added to gelatinized starch such that β-amylase is 0.64% (dry mass basis) and transglucosidase is 0.6% (dry mass basis) (enzyme unit ratio of two added enzymes is 660:1 in accordance with the enzyme unit defined in the present invention) and allowed to act, and the mixture is added with an equivalent of ethanol and centrifuged to obtain a precipitate is known. However, in addition to the fact that the substrate concentration of the gelatinized starch was only about 4%, this method of production requires an ethanol precipitation operation. Thus, the method is less than an efficient method of production.

In addition, for instance, a method of production characterized in that β-amylase and transglucosidase which is a type of α-glucosidase are simultaneously added to a dextrin solution with a solid concentration of not less than 20% such that the concentration of β-amylase is 0.3 to 1.2% by weight and that of transglucosidase is 0.02 to 0.4 IU/g (enzyme ratio of two added enzymes is 103:1 to 8241:1 in accordance with the enzyme unit defined in the present invention) and allowed to act to generate a branched oligosaccharide (Patent Document 4) is known. But the branched oligosaccharide generated by this method of production has a high osmotic pressure and thus, addition of the branched oligosaccharide with no modifications to nutritional supplement products is limited. As a matter of fact, even though isomaltooligosaccharides produced by this method of production are currently produced at an industrial level, the isomaltooligosaccharides have never been used as energy sources of nutritional supplement products.

[Patent Document 1] Japanese Patent Application Laid-Open Publication No. 2001-11101

[Patent Document 2] Japanese Patent Application Laid-Open Publication No. 2005-213496

[Patent Document 3] US2007/0172931

[Patent Document 4] Japanese Patent Application Laid-Open Publication No. 61-219345

[Non-patent Document 1] J. Agric. Food Chem. 2007, 55, 4540-4547

### DISCLOSURE OF THE INVENTION

### Problems to be Solved by the Invention

An object of the present invention is to provide, in view of the above-described circumstances, a branched dextrin insusceptible to digestion and having a low osmotic pressure, as well as a method for efficiently producing such a branched dextrin.

Another object of the present invention is to provide food products and beverages such as nutritional supplement products, diet food, energy supplying drinks, nutritional supplement food products and the like containing the above-mentioned branched dextrin.

Further, another object of the present invention is to provide energy lasting products and agents causing a stick-to-the-ribs feeling containing the above-mentioned branched dextrin.

### Means for Solving the Problems

The present inventors intensively studied a method for producing branched dextrin insusceptible to digestion and having a low osmotic pressure and, as a result, they particularly focused attention on a unit ratio of two added enzymes in production of the isomaltooligosaccharide wherein β-amylase and transglucosidase are simultaneously allowed to act on a dextrin solution to produce branched dextrin.

In the present specification, in accordance with definitions described in “Amylase” published by Japan Scientific Societies Press (supervised by Michinori Nakamura, edited by Masatake Ohnishi and three others, published in 1986), among maltose-generating amylases, an amylase which generates α-maltose is referred to as α-maltose-generating amylase whereas an amylase which generates β-maltose is referred to as β-amylase or β-maltose-generating amylase.

The branched dextrin obtained at the conventional enzyme ratio for production of isomaltooligosaccharides was insusceptible to digestion but had a high osmotic pressure, and use thereof without modification was limited. The present inventors found out that, by setting an enzyme unit ratio of two added enzymes in a nonconventional particular range, surprisingly, a branched dextrin having both properties of less susceptibility to digestion and lower osmotic pressure can be produced. That is, they found out that when maltose-generating amylase and transglucosidase, which are prepared such that the enzyme unit ratio is 2:1 to 44:1, are allowed to act on a dextrin solution with a solid concentration of preferably not less than 20% by weight, branched dextrin insusceptible to digestion and having a low osmotic pressure can be produced, thereby completing the present invention.

That is, the present invention is to provide a branched dextrin described below and a method for producing such the branched dextrin.

1. A branched dextrin having a structure wherein glucose or isomalto oligosaccharide is linked to a non-reducing terminal of a dextrin through an α-1,6 glucosidic bond and having a DE of 10 to 52.
2. The branched dextrin according to 1 described above, wherein the osmotic pressure of 10% by weight aqueous solution thereof is 70 to 300 mOSMOL/kg.
3. A food product and beverage containing the branched dextrin according to 1 or 2 described above.
4. The food product and beverage according to 3 described above which is a diet food, energy supplying drink, energy lasting food product or nutritional supplement food product.
5. A nutritional supplement product containing the branched dextrin according to 1 or 2 described above.
6. An energy lasting product containing the branched dextrin according to 1 or 2 described above.
7. An agent causing a stick-to-the-ribs feeling containing the branched dextrin according to 1 or 2 described above.
8. A method for producing the branched dextrin according to 1 or 2 described above, characterized in that, in a method for producing a branched dextrin by allowing maltose-generating amylase and transglucosidase to act on an aqueous dextrin solution, the maltose-generating amylase and the transglucosidase are adjusted so as to attain an enzyme unit ratio of 2:1 to 44:1 and allowed to act.
9. The method for producing the branched dextrin according to 8 described above, wherein the maltose-generating amylase is an α-maltose-generating amylase.
10. The method for producing the branched dextrin according to 8 or 9 described above, wherein the DE of the dextrin is 2 to 20.
11. The method for producing the branched dextrin according to any one of 8 to 10 described above, wherein the concentration of the dextrin is 20 to 50% by weight.
12. The method for producing the branched dextrin according to any one of 8 to 11 described above, wherein the dextrin is an acid hydrolysate of a starch.

### EFFECTS OF THE INVENTION

According to the present invention, a branched dextrin insusceptible to digestion, therefore, having a low glycemic index (low GI), and, in addition, having a low osmotic pressure can be efficiently obtained. A method for producing the branched dextrin of the present invention is very simple and convenient as well as efficient in that only one step of enzyme treatment in addition to an ordinary production process of dextrins is required, and in that, enzymes to be used are commercially available, and a desired branched dextrin can be obtained only by adjusting the unit ratio of added enzymes.

Since an increase in blood glucose values after intake of the branched dextrin obtained by the method of the present invention is slow, application thereof to a wide range of the fields of medical food products and food products such as saccharide sources of nutritional supplement products for diabetics, diet food, energy supplying food products, in particular, long-lasting type energy supplying food products, or nutritional supplement food products can be expected.

### BEST MODE FOR CARRYING OUT THE INVENTION

The term “branched dextrin” in the present specification refers to a dextrin obtained by hydrolyzing ordinary starch by a known method, which dextrin has a higher percentage of branched structures composed of α-1,6 glucosidic bonds, compared with the so-called ordinary dextrin.

The term “enzyme unit of maltose-generating amylase” in the present invention is defined, as one unit, an enzyme ability to generate 1 μmol of maltose in one minute using 5% by weight dextrin aqueous solution (dextrin: PDx#2 (DE=11, number average molecular weight=1700, average polymerization degree=10): manufactured by Matsutani Chemical Industry Co., Ltd.) as a substrate under reaction conditions with pH 5.5 and a reaction temperature of 55° C. In addition, an “enzyme unit of transglucosidase” is defined, as one unit, an enzyme ability to generate 1 μmol of glucose in one minute using 1% by weight methyl-α-D-glucopyranoside aqueous solution as a substrate under reaction condition with pH 5.5 and a reaction temperature of 55° C.

Osmotic pressure in the present invention is a value wherein an aqueous solution prepared to Brix 10% is measured by freezing point depression method using an osmometer (VOGEL OM802-D). The osmotic pressure of the branched dextrin of the present invention is preferably about 90 to 300 mOSMOL/kg, more preferably 100 to 200 mOSMOL/kg.

DE in the present description is a value represented by an equation of “[(mass of direct reducing sugar (in terms of glucose))/(mass of solids content)]×100” and an analysis value by Willstatter-Schudel method. The DE of the branched dextrin of the present invention is 10 to 52, preferably 10 to 40.

The branched dextrin of the present invention can be prepared by simultaneously adding a maltose generating amylase and one type of α-glucosidase, transglucosidase, which enzymes are prepared such that the enzyme unit ratio is about 2:1 to 44:1, preferably 10:1 to 30:1, to a dextrin obtained by hydrolyzing starch by a known method to allow to act. In cases where the enzyme ratio is out of the range of 2:1 to 44:1, it is difficult to prepare a branched dextrin having both properties of less susceptibility to digestion and lower osmotic pressure.

Concretely, starch is first hydrolyzed by the known method to obtain dextrin. As starch serving as the starting material, for instance, underground starch such as tapioca starch, sweet potato starch or potato starch; ground starch such as cornstarch, waxy-corn starch or rice starch; or the like can be used. The DE of dextrin may be preferably about 2 to 20, more preferably about 5 to 12. Too low DE causes white turbidity (retrogradation) when dextrins are stored in the form of solution. Contrarily, too high DE causes higher osmotic pressure in a final product.

As a method for hydrolyzing starch, there are enzymatic hydrolysis by α-amylase or the like, acid hydrolysis and a combination thereof. Even though any one of the methods can be used, the acid hydrolysis is preferred in view of shortening the process and lowering the viscosity of the generated branched dextrin. As an acid, oxalic acid, hydrochloric acid or the like can be used and oxalic acid is preferred. For instance, hydrolysis may be carried out by adding powdered oxalic acid to 30% by weight tapioca starch aqueous solution, adjusting the pH to 1.8 to 2.0 and subjecting to a treatment at 100 to 130° C. for about 40 to 80 minutes.

Next, the concentration of dextrin is preferably adjusted to 20 to 50% by weight, more preferably to 20 to 40% by weight and the pH thereof is preferably adjusted to 4.0 to 7.0, more preferably about 5.5. To this, an appropriate amount (for instance, preferably about 0.1 to 1.0 part by weight based on 100 parts by weight of dextrin aqueous solution) of a mixture of maltose-generating amylase and transglucosidase, which mixture is adjusted such that the enzyme unit ratio is about 2:1 to 44:1, preferably 10:1 to 30:1, is added and an enzyme reaction is preferably carried out at 50 to 60° C., more preferably at about 55° C., preferably for 0.25 to 44 hours, still more preferably 0.5 to 3.0 hours.

Subsequently, treatment to inactivate the enzymes in the reaction mixture is carried out. For instance, the enzyme reaction of maltose-generating amylase and transglucosidase is terminated by carrying out a treatment at 95° C. for 30 minutes or by adjusting the pH to 3.5 or lower with an acid.

As maltose-generating amylases, commercially available ones can be used. For instance, Biozyme ML (manufactured by Amano Enzyme Inc.) and β-amylase#15005 (manufactured by Nagase ChemteX Corporation) are β-maltose-generating amylase (β-amylase). Biozyme L (manufactured by Amano Enzyme Inc.) is α-maltose-generating amylase. Among the enzymes, Biozyme L is preferred in that it generates a branched dextrin with superior stability against retrodegradation. Also, as transglucosidase, a commercially available one can similarly be used. Examples thereof include transglucosidase L “Amano” (manufactured by Amano Enzyme Inc.) and transglucosidase L-500 (manufactured by Genencor Kyowa Co. Ltd.) and the like.

In the above-described enzyme reaction, as required, α-amylase may be simultaneously added and allowed to act, or may be allowed to act after the reaction. In addition, these enzyme reactions may be carried out using free enzymes or immobilized ones. In the case of the immobilized enzyme, a method for reaction may be either a batch method or continuous method. As a method of immobilization, a known method such as a carrier binding method, an entrapment method or a cross-linking method can be used.

Finally, desalting is carried out by a known method using activated carbon treatment, diatomaceous earth filtration, ion exchange resin or the like to obtain a powdered product by concentration followed by spray drying, or a liquid product by concentrating to about 70% by weight. Further, the above-mentioned enzyme reaction solution may be subjected to fractionation treatment using chromatographic separation device or membrane separation device to separate and eliminate low molecular weight ingredients which cause an increase in osmotic pressure until the amount of the ingredients reaches the requisite minimum amount.

The thus obtained branched dextrin has a structure wherein glucose or isomaltooligosaccharide is linked to a non-reducing terminal of a starch decomposition product (dextrin) having a branched structure and/or linear structure in the molecule through an α-1,6 glucosidic bond, as well as having a DE of 10 to 52. And, the osmotic pressure thereof is preferably about 70 to 300 mOSMOL/kg, more preferably 100 to 200 mOSMOL/kg.

In addition, the percentage of glucose whose non-reducing terminal is linked to glucose or isomaltooligosaccharide through an α-1,6 glucosidic bond, that is, “→6)-Glcp-(1→” is preferably not less than 5% by weight, further preferably not less than 8% by weight, particularly preferably 10 to 30% by weight. The percentage of glucose having an inner branched structure, that is “→4,6)-Glcp-(1→” is preferably 5 to 13% by weight, further preferably 6 to 10% by weight.

These percentages of the linkages can be determined by the method of Ciucanu et al., which is a modified process of the methylation analysis method of Hakomori (Carbohydr. Res., 1984, 131, 209-217).

Since this branched dextrin is slowly digested and absorbed, thus has low GI and, in addition, has a low osmotic pressure, application thereof to a wide range of the fields of medical food products and food products such as saccharide sources of nutritional supplement products for diabetics, diet food, energy supplying food products, or nutritional supplement food products can be expected.

The branched dextrin of the present invention can be used as the above-mentioned nutritional supplement products or food products with no modifications. Yet, it is appropriate that the branched dextrin is preferably contained in enteral nutrition products, meal substitute drinks, long-lasting type energy supplying products or jellies at 10 to 50% by weight, more preferably at about 20 to 40% by weight.

Additionally, in cases where the branched dextrin of the present invention is used for the above-mentioned food products and beverages or nutritional supplement products such as enteral nutrition products, meal substitute drinks, long-lasting type energy supplying products or jellies, it can be expected that the effect will be more enhanced by co-employing other functional food materials such as indigestible dextrins.

The present invention will now be described concretely by way of examples and test examples thereof. Yet, the present invention is not restricted to the examples.

First, in order to examine effect of an unit ratio of β-amylase and transglucosidase on properties of branched dextrins, that is, the properties of less susceptibility to digestion and lower osmotic pressure, branched dextrins were prepared using the enzymes with the enzyme unit ratio shown in Table 1, in Examples 1 to 3 and Comparative Examples 1 to 4.

TABLE 1

| | Unit Ratio of Added Enzymes |
|---|---|
| | (β-amylase:Transglucosidase) |
| Example 1 | 2:1 |
| Example 2 | 21:1 |
| Example 3 | 44:1 |
| Comparative Example 1 | 0:1 (transglucosidase alone) |
| Comparative Example 2 | 132:1 |
| Comparative Example 3 | 330:1 |
| Comparative Example 4 | 660:1 |

### Example 1

### Effect of Unit Ratio Between β-Amylase and Transglucosidase on Properties of Branched Dextrins

Dextrin (PDX#1: manufactured by Matsutani Chemical Industry Co., Ltd./DE=8) (150 g) was dissolved in 150 g of a buffer solution (0.1 M phosphate buffer (pH 5.5)). 95 units of β-amylase (Biozyme ML: manufactured by Amano Enzyme Inc.) and 45 units of transglucosidase (transglucosidase L “Amano”: manufactured by Amano Enzyme Inc.) were simultaneously added to attain a condition with an enzyme unit ratio of 2:1 and a reaction was initiated at 55° C. 90 minutes and 180 minutes after the beginning of the reaction, a portion was sampled and kept individually at 95° C. for 15 minutes to terminate the reaction. The samples were individually filtered using diatomaceous earth and desalted using amphoteric ion-exchange resin (manufactured by Organo Corporation) to obtain branched dextrins with an osmotic pressure of 108 mOSMOL/kg and 181 mOSMOL/kg, respectively. (DEs thereof were 15.3 and 24.9, respectively.)

### Test Example 1

### In Vitro Digestibility Test

An in vitro digestibility test was carried out for the obtained branched dextrin.

The “in vitro digestibility test” in the present invention is a mock test for saccharide digestibility in vivo and a test in which saccharides (dextrins in the case of the present invention) are decomposed by an enzyme mixture solution (swine pancreatic amylase and rat small intestinal mucosal enzyme) and the amount of glucose released is measured with time in accordance with a modified method based on the method of Englyst et al. (European Journal of Clinical Nutrition, 1992, 46 S33-S50).

As for the swine pancreatic amylase to be used, one manufactured by Roche (19230 U/ml) was used. Also, as for the rat small intestinal mucosal enzyme, rat small intestinal acetone powder manufactured by Sigma was prepared as follows and used. That is, 1.2 g of rat small intestinal acetone powder was suspended in 15 ml of 45 mM Bis-Tris.Cl Buffer (pH 6.6)/0.9 mM CaCl₂. The mixture was homogenized and then centrifuged at 3000 rpm for 10 minutes. The supernatant was used as a crude enzyme solution of rat small intestinal mucosal enzyme. The activity of the crude enzyme solution was calculated using an activity thereof to decompose 1 mmol of maltose in 26 mM maltose solution for 1 minute as 1 U.

A test substance was dissolved in a buffer solution (45 mM Bis-Tris.Cl Buffer (pH 6.6)/0.9 mM CaCl₂) to prepare 0.24% by weight test substance solution. As for the test substance, a general dextrin (TK-16: manufactured by Matsutani Chemical Industry Co., Ltd./DE=18) as a control, as well as the branched dextrins obtained in Example 1 whose osmotic pressure were 108 mOSMOL/kg and 181 mOSMOL/kg were used. Each (2.5 ml) of these test substance solutions was placed in a test tube and warmed at 37° C. for 10 minutes in an incubator. Thereafter, 0.5 ml of an enzyme mixture solution (50 μl of swine pancreatic amylase (384.6 U/ml)+140 μl of rat small intestinal mucosal enzyme (6.0 U/ml)+310 μl of buffer solution) was added to each and mixed well to initiate a reaction. 15 seconds, 10 minutes, 30 minutes, 1 hour, 1.5 hours, 2 hours, 3 hours, 4 hours and 6 hours after the beginning of the reaction, 200 μl of each of the reaction solution and 50 μl of 0.5 M perchloric acid were mixed to terminate the reaction. The glucose concentration of these solution in which the reaction was terminated was quantified using Glucose CII Test Wako (manufactured by Wako Pure Chemical Industries, Ltd.). From the results shown in FIG. 1, it was confirmed that both of the branched dextrins obtained in Example 1 were less susceptible to digestion by swine pancreatic amylase and rat small intestinal mucosal enzyme than TK-16, and slowly digested.

### Example 2

### Effect of Unit Ratio Between β-Amylase and Transglucosidase on Properties of Branched Dextrins

Dextrin (PDX#1: manufactured by Matsutani Chemical Industry Co., Ltd./DE=8) (150 g) was dissolved in 150 g of a buffer solution (0.1 M phosphate buffer (pH 5.5)). 950 units of β-amylase (Biozyme ML: manufactured by Amano Enzyme Inc.) and 45 units of transglucosidase (transglucosidase L “Amano”: manufactured by Amano Enzyme Inc.) were simultaneously added to attain a condition with an enzyme unit ratio of 21:1 and a reaction was initiated at 55° C. 30 minutes and 180 minutes after the beginning of the reaction, a portion was sampled and kept individually at 95° C. for 15 minutes to terminate the reaction. The samples were individually filtered using diatomaceous earth and desalted using amphoteric ion-exchange resin (manufactured by Organo Corporation) to obtain branched dextrins with an osmotic pressure of 105 mOSMOL/kg and 189 mOSMOL/kg, respectively. (DEs thereof were 14.9 and 26.9, respectively.)

For the obtained branched dextrins, an in vitro digestibility test similar to Test Example 1 was carried out. From the results shown in FIG. 2, it was confirmed that both of the branched dextrins obtained in Example 2 were, compared with TK-16, less susceptible to digestion by swine pancreatic amylase and rat small intestinal mucosal enzyme and slowly digested.

### Example 3

### Effect of Unit Ratio Between β-Amylase and Transglucosidase on Properties of Branched Dextrins

Dextrin (PDX#1: manufactured by Matsutani Chemical Industry Co., Ltd./DE=8) (150 g) was dissolved in 150 g of a buffer solution (0.1 M phosphate buffer (pH 5.5)). 1782 units of β-amylase (Biozyme ML: manufactured by Amano Enzyme Inc.) and 40.5 units of transglucosidase (transglucosidase L “Amano”: manufactured by Amano Enzyme Inc.) were simultaneously added to attain a condition with an enzyme unit ratio of 44:1 and a reaction was initiated at 55° C. 15 minutes and 90 minutes after the beginning of the reaction, a portion was sampled and kept individually at 95° C. for 15 minutes to terminate the reaction. The samples were individually filtered using diatomaceous earth and desalted using amphoteric ion-exchange resin (manufactured by Organo Corporation) to obtain branched dextrins with an osmotic pressure of 103 mOSMOL/kg and 178 mOSMOL/kg, respectively. (DEs thereof were 13.1 and 23.8, respectively.)

For the obtained branched dextrins, an in vitro digestibility test similar to Test Example 1 was carried out. From the results shown in FIG. 3, it was confirmed that the branched dextrin with an osmotic pressure of 178 mOSMOL/kg, which branched dextrin was obtained 90 minutes after the beginning of the reaction in Example 3, was, compared with TK-16, less susceptible to digestion by swine pancreatic amylase and rat small intestinal mucosal enzyme and slowly digested. Meanwhile, the branched dextrin with an osmotic pressure of 103 mOSMOL/kg had almost the same digestibility as the control, TK-16.

### Comparative Example 1

### Effect of Unit Ratio Between β-Amylase and Transglucosidase on Properties of Branched Dextrins

Dextrin (PDX#1: manufactured by Matsutani Chemical Industry Co., Ltd./DE=8) (150 g) was dissolved in 150 g of a buffer solution (0.1 M phosphate buffer (pH 5.5)). Only transglucosidase (54 units) (transglucosidase L “Amano”: manufactured by Amano Enzyme Inc.) was added and a reaction was initiated at 55° C. 60 minutes and 480 minutes after the beginning of the reaction, a portion was sampled and kept individually at 95° C. for 15 minutes to terminate the reaction. The samples were individually filtered using diatomaceous earth and desalted using amphoteric ion-exchange resin (manufactured by Organo Corporation) to obtain branched dextrins with an osmotic pressure of 106 mOSMOL/kg and 179 mOSMOL/kg, respectively. (DEs thereof were 14.6 and 26.8, respectively.)

For the obtained branched dextrins, an in vitro digestibility test similar to Test Example 1 was carried out. From the results shown in FIG. 4, it was confirmed that the branched dextrins obtained in Comparative Example 1 had almost the same digestibility as the control, TK-16.

### Comparative Example 2

### Effect of Unit Ratio Between β-Amylase and Transglucosidase on Properties of Branched Dextrins

Dextrin (PDX#1: manufactured by Matsutani Chemical Industry Co., Ltd./DE=8) (150 g) was dissolved in 150 g of a buffer solution (0.1 M phosphate buffer (pH 5.5)). 2970 units of β-amylase (Biozyme ML: manufactured by Amano Enzyme Inc.) and 22.5 units of transglucosidase (transglucosidase L “Amano”: manufactured by Amano Enzyme Inc.) were simultaneously added to attain a condition with an enzyme unit ratio of 132:1 and a reaction was initiated at 55° C. 15 minutes and 60 minutes after the beginning of the reaction, a portion was sampled and kept individually at 95° C. for 15 minutes to terminate the reaction. The samples were individually filtered using diatomaceous earth and desalted using amphoteric ion-exchange resin (manufactured by Organo Corporation) to obtain branched dextrins with an osmotic pressure of 124 mOSMOL/kg and 184 mOSMOL/kg, respectively. (DEs thereof were 17.1 and 26.1, respectively.)

For the obtained branched dextrins, an in vitro digestibility test similar to Test Example 1 was carried out. From the results shown in FIG. 5, it was confirmed that the branched dextrins obtained in Comparative Example 2 had almost the same digestibility as the control, TK-16.

### Comparative Example 3

### Effect of Unit Ratio Between β-Amylase and Transglucosidase on Properties of Branched Dextrins

Dextrin (PDX#1: manufactured by Matsutani Chemical Industry Co., Ltd./DE=8) (150 g) was dissolved in 150 g of a buffer solution (0.1 M phosphate buffer (pH 5.5)). 2970 units of β-amylase (Biozyme ML: manufactured by Amano Enzyme Inc.) and 9 units of transglucosidase (transglucosidase L “Amano”: manufactured by Amano Enzyme Inc.) were simultaneously added to attain a condition with an enzyme unit ratio of 330:1 and a reaction was initiated at 55° C. 15 minutes and 75 minutes after the beginning of the reaction, a portion was sampled and kept individually at 95° C. for 15 minutes to terminate the reaction. The samples were individually filtered using diatomaceous earth and desalted using amphoteric ion-exchange resin (manufactured by Organo Corporation) to obtain branched dextrins with an osmotic pressure of 125 mOSMOL/kg and 191 mOSMOL/kg, respectively. (DEs thereof were 17.0 and 27.4, respectively.)

For the obtained branched dextrins, an in vitro digestibility test similar to Test Example 1 was carried out. From the results shown in FIG. 6, it was confirmed that the branched dextrins obtained in Comparative Example 3 had almost the same digestibility as the control, TK-16.

### Comparative Example 4

### Effect of Unit Ratio Between β-Amylase and Transglucosidase on Properties of Branched Dextrins

Dextrin (PDX#1: manufactured by Matsutani Chemical Industry Co., Ltd./DE=8) (150 g) was dissolved in 150 g of a buffer solution (0.1 M phosphate buffer (pH 5.5)). 4930.2 units of β-amylase (Biozyme ML: manufactured by Amano Enzyme Inc.) and 7.47 units of transglucosidase (transglucosidase L “Amano”: manufactured by Amano Enzyme Inc.) were simultaneously added to attain a condition with an enzyme unit ratio of 660:1 and a reaction was initiated at 55° C. 15 minutes and 45 minutes after the beginning of the reaction, a portion was sampled and kept individually at 95° C. for 15 minutes to terminate the reaction. The samples were individually filtered using diatomaceous earth and desalted using amphoteric ion-exchange resin (manufactured by Organo Corporation) to obtain liquid products of branched dextrins with an osmotic pressure of 143 mOSMOL/kg and 194 mOSMOL/kg, respectively. (DEs thereof were 19.9 and 29.6, respectively.)

For the obtained branched dextrins, an in vitro digestibility test similar to Test Example 1 was carried out. From the results shown in FIG. 7, it was confirmed that the branched dextrins obtained in Comparative Example 4 had almost the same digestibility as the control, TK-16.

Table 2 summarizes the results of evaluation of the digestibility obtained by the in vitro digestibility test carried out for the above branched dextrins obtained in the Examples 1 to 3 and Comparative Examples 1 to 4.

TABLE 2

| | | | Osmotic | |
|---|---|---|---|---|
| | | | Pressure of | Digestibility |
| | Unit Ratio of | Reaction | Product | (in vitro |
| | Enzymes | Time | (mOSMOL/ | digestibility |
| | (β*:TG**) | (minutes) | kg) | test) |
| Example 1 | 2:1 | 90 | 108 | Slowly |
| | | | | digested |
| | | 180 | 181 | Slowly |
| | | | | digested |
| Example 2 | 21:1 | 30 | 105 | Slowly |
| | | | | digested |
| | | 180 | 189 | Slowly |
| | | | | digested |
| Example 3 | 44:1 | 15 | 103 | Same as the |
| | | | | control |
| | | 90 | 178 | Slowly |
| | | | | digested |
| Comparative | 0:1 | 60 | 106 | Same as the |
| Example 1 | (transglucosidase | | | control |
| | alone) | 480 | 179 | Same as the |
| | | | | control |
| Comparative | 132:1 | 15 | 124 | Same as the |
| Example 2 | | | | control |
| | | 60 | 184 | Same as the |
| | | | | control |
| Comparative | 330:1 | 15 | 125 | Same as the |
| Example 3 | | | | control |
| | | 75 | 191 | Same as the |
| | | | | control |
| Comparative | 660:1 | 15 | 143 | Same as the |
| Example 4 | | | | control |
| | | 45 | 194 | Same as the |
| | | | | control |

*β-amylase,
**transglucosidase

From Table 2, it was confirmed that the branched dextrins having both properties of less susceptibility to digestion and lower osmotic pressure were able to be obtained when the enzyme unit ratio between β-amylase and transglucosidase was within a range of 2:1 to 44:1 whereas similar branched dextrins were not able to be obtained when the enzyme unit ratio was out of the range of 2:1 to 44:1.

### Example 4

### Effect of Substrate Concentration on Properties of Branched Dextrins and Reaction Efficiency

Dextrin (PDX#1: manufactured by Matsutani Chemical Industry Co., Ltd./DE=8) (150 g), which served as a substrate, was dissolved using a buffer solution (0.1 M phosphate buffer (pH 5.5)) such that the substrate concentration is 20% by weight, 30% by weight, 40% by weight, 50% by weight or 60% by weight. To each solution, 950 units of β-amylase (Biozyme ML: manufactured by Amano Enzyme Inc.) and 45 units of transglucosidase (transglucosidase L “Amano”: manufactured by Amano Enzyme Inc.) were simultaneously added to attain a condition with an enzyme unit ratio of 21:1 and a reaction was initiated at 55° C. Reaction time at each substrate concentration as well as osmotic pressure and DE of the obtained branched dextrin are shown in Table 3.

TABLE 3

| Substrate | Reaction | Osmotic | |
|---|---|---|---|
| Concentration | Time | Pressure | |
| (% by weight) | (minutes) | (mOSMOL/kg) | DE |
| 20 | 75 | 185 | 26.0 |
| 30 | 75 | 180 | 25.9 |
| 40 | 75 | 178 | 24.2 |
| 50 | 140 | 189 | 27.0 |
| 60 | 300 | 187 | 26.6 |

For the branched dextrins obtained under the conditions shown in Table 3, an in vitro digestibility test similar to Test Example 1 was carried out. From the results shown in FIG. 8, it was confirmed that the obtained branched dextrins were, compared with TK-16, less susceptible to digestion by swine pancreatic amylase and rat small intestinal mucosal enzyme and slowly digested to a similar extent under any conditions of substrate concentration.

From the results of Table 3 and FIG. 8, it was confirmed that the branched dextrin having both properties of less susceptibility to digestion and lower osmotic pressure can be produced at any substrate concentrations. In addition, it was confirmed that the lower the substrate concentration is, the shorter the reaction time is and the better the reaction efficiency is.

### Example 5

### Effect of Amount of Added Enzyme on Properties of Branched Dextrins

Dextrin (PDX#1: manufactured by Matsutani Chemical Industry Co., Ltd./DE=8) (125 g) was dissolved in 125 g of a buffer solution (0.1 M phosphate buffer (pH 5.5)). The unit shown in the conditions 1 and 2 of Table 4 of enzymes (the enzyme unit ratio of β-amylase and transglucosidase was 21:1 in both conditions but the amount of added enzymes differed) was each added at the same time to initiate reactions at 55° C. For the condition 1, 44 hours after the beginning of the reaction and, for the condition 2, 2.5 hours after the beginning of the reaction, a portion was sampled and kept individually at 95° C. for 15 minutes to terminate the reaction. The samples were individually filtered using diatomaceous earth and desalted using amphoteric ion-exchange resin (manufactured by Organo Corporation) to obtain liquid products of branched dextrin with an osmotic pressure of 188 mOSMOL/kg and 193 mOSMOL/kg, respectively. (DEs thereof were 27.6 and 28.3, respectively.)

TABLE 4

| | | Transglu- | | | |
|---|---|---|---|---|---|
| | β-amylase* | cosidase** | Reaction | Osmotic | |
| | (U/g of | (U/g of | Time | Pressure | |
| | substrate) | substrate) | (hours) | (mOSMOL/kg) | DE |
| Condi- | 0.63 | 0.03 | 44 | 188 | 27.6 |
| tion 1 | | | | | |
| Condi- | 6.30 | 0.30 | 2.5 | 193 | 28.3 |
| tion 2 | | | | | |

*Biozyme ML: Manufactured by Amano Enzyme Inc.
**Transglucosidase L “Amano”: Manufactured by Amano Enzyme Inc.

For the branched dextrins obtained under the reaction conditions shown in Table 4, an in vitro digestibility test similar to Test Example 1 was carried out. From the results shown in FIG. 9, it was confirmed that the obtained branched dextrins were, compared with TK-16, more insusceptible to digestion by swine pancreatic amylase and rat small intestinal mucosal enzyme and slowly digested to a similar extent at any amount(s) of the added enzymes.

Yet, it was confirmed that, in cases where the amount of the added enzymes was reduced while the enzyme unit ratio was kept the same, the time required to produce the branched dextrin with a desired osmotic pressure increased.

### Example 6

### Effect of Types of Maltose-Generating Amylase on Properties of Branched Dextrins

Dextrin (PDX#1: manufactured by Matsutani Chemical Industry Co., Ltd./DE=8) (125 g) was dissolved in 125 g of a buffer solution (0.1 M phosphate buffer (pH 5.5)). Enzymes shown in the conditions 1 and 2 of Table 5 (950 units of maltose-generating amylase and 45 units of transglucosidase, that is, the enzyme unit ratio of the enzymes was 21:1 in each condition) was each added at the same time to initiate reactions at 55° C. In both of the conditions 1 and 2, 1.5 hours after the beginning of the reaction, samples were kept individually at 95° C. for 15 minutes to terminate the reaction. The samples were individually filtered using diatomaceous earth and desalted using amphoteric ion-exchange resin (manufactured by Organo Corporation) to obtain liquid products of branched dextrin with an osmotic pressure of 143 mOSMOL/kg and 145 mOSMOL/kg, respectively. (DEs thereof were 21.2 and 21.2, respectively.)

TABLE 5

| | Maltose- | | Reaction | Osmotic | |
|---|---|---|---|---|---|
| | generating | Transglu- | Time | Pressure | |
| | amylase | cosidase | (hours) | (mOSMOL/kg) | DE |
| Condi- | β-maltose- | Transglu- | 1.5 | 143 | 21.2 |
| tion 1 | generating | cosidase*** | | | |
| | amylase* | | | | |
| Condi- | α-maltose- | | 1.5 | 145 | 21.2 |
| tion 2 | generating | | | | |
| | amylase** | | | | |

*Biozyme ML (Manufactured by Amano Enzyme Inc.)
**Biozyme L (Manufactured by Amano Enzyme Inc.)
***Transglucosidase L “Amano” (Manufactured by Amano Enzyme Inc.)

For the branched dextrins obtained in the conditions shown in Table 5, an in vitro digestibility test similar to Test Example 1 was carried out. From the results shown in FIG. 10, it was confirmed that the obtained branched dextrins were, compared with TK-16, less susceptible to digestion by swine pancreatic amylase and rat small intestinal mucosal enzyme and slowly digested to a similar extent in any conditions.

### (Stability Test Against Retrogradation)

Next, for the branched dextrin solution of Table 5 obtained in Example 6, a “stability test against retrogradation” was carried out. In the “stability test against retrogradation” in the present invention, a solution adjusted to Brix 50% is frozen at −20° C., thawed at room temperature, and adjusted to Brix 30, followed by measurement of the turbidity of the solution using a spectrophotometer (OD 720 nm, in terms of 1 cm cell). It is a method for measuring the turbidity of the solution wherein this operation is carried out until the turbidity of the solution increases or repeated five times. In this method, evaluation is carried out from viewpoints of the fact that dextrins with bad stability against retrogradation show an increase in the turbidity of solution thereof before the operation is repeated five times while dextrins with good stability against retrogradation do not show an increase even after 5 repeats of the operation. The results of stability test against retrogradation are shown in Table 6. From the results of Table 6, it was confirmed that the branched dextrin obtained by allowing α-maltose-generating amylase to act in the condition 2 is superior in the stability against retrogradation.

TABLE 6

| | Maltose- | Turbidity of Solution | | | | |
|---|---|---|---|---|---|---|
| | Generating | 1st | 2nd | 3rd | 4th | 5th |
| | Amylase | Round | Round | Round | Round | Round |
| Condi- | β-maltose- | 0.00 | 0.88 | 3.16 | — | — |
| tion 1 | generating | | | | | |
| | amylase | | | | | |
| Condi- | α-maltose- | 0.00 | 0.00 | 0.00 | 0.00 | 0.00 |
| tion 2 | generating | | | | | |
| | amylase | | | | | |

### Example 7

### Effect of DE of Dextrin Serving as Raw Material on Properties of Branched Dextrins

Tapioca starch was decomposed by the known method of decomposition shown in Table 7. And, 125 g of dextrin decomposed to DE shown in Table 7 was dissolved in 125 g of a buffer solution (0.1 M phosphate buffer (pH5.5)). To each, 950 units of α-maltose-generating amylase (Biozyme L: manufactured by Amano Enzyme Inc.) and 45 units of transglucosidase (transglucosidase L “Amano”: manufactured by Amano Enzyme Inc.), that is, ones which were prepared such that the enzyme unit ratio is 21:1, were simultaneously added, allowed to act for the time shown in Table 7, thereafter kept individually at 95° C. for 15 minutes to terminate the reaction. The samples were individually filtered using diatomaceous earth and desalted using amphoteric ion-exchange resin (manufactured by Organo Corporation) to obtain liquid products of branched dextrins with the osmotic pressure shown in Table 7.

TABLE 7

| | Dextrin Serving as | | | | |
|---|---|---|---|---|---|
| | Raw Material | | Reaction | Osmotic | |
| | Method of | | Time | Pressure | |
| | Decomposition | DE | (hours) | (mOSMOL/kg) | DE |
| Condition 1 | α-amylase | 6.0 | 1.5 | 143 | 21.2 |
| Condition 2 | α-amylase | 8.0 | 1.5 | 145 | 21.2 |
| Condition 3 | α-amylase | 12.0 | 1.0 | 139 | 20.6 |
| Condition 4 | Acid | 11.9 | 1.25 | 140 | 20.7 |

For the branched dextrins obtained under the conditions shown in Table 7, an in vitro digestibility test similar to Test Example 1 was carried out. From the results shown in FIG. 11, it was confirmed that the obtained branched dextrins were, compared with TK-16, more insusceptible to digestion by swine pancreatic amylase and rat small intestinal mucosal enzyme and slowly digested to a similar extent under any conditions.

Next, for the obtained branched dextrin solution of Table 7, a stability test against retrogradation similar to Example 6 was carried out. From the results of Table 8, it was confirmed that the stability of the branched dextrin against retrogradation was good under any conditions.

TABLE 8

| | Dextrin Serving as | | | | | | |
|---|---|---|---|---|---|---|---|
| | Raw Material | | Turbidity of Solution | | | | |
| | Method of | | 1st | 2nd | 3rd | 4th | 5th |
| | Decomposition | DE | Round | Round | Round | Round | Round |
| Condition 1 | α-amylase | 6.0 | 0.00 | 0.00 | 0.00 | 0.00 | 0.00 |
| Condition 2 | α-amylase | 8.0 | 0.00 | 0.00 | 0.00 | 0.00 | 0.00 |
| Condition 3 | α-amylase | 12.0 | 0.00 | 0.00 | 0.00 | 0.00 | 0.00 |
| Condition 4 | Acid | 11.9 | 0.00 | 0.00 | 0.00 | 0.00 | 0.00 |

(Measurement of Viscosity)

For the branched dextrin solution of Table 7 obtained Example 7, “viscosity” was measured. The “viscosity” in the present invention is measured by VISCOMETER MODEL BM under the following conditions. Concentration: 30% by weight, Measuring temperature: 30° C., Revolution: 60 rpm, Hold time: 30 seconds.

From the results of Table 9, it was confirmed that the branched dextrin obtained by using the raw material decomposed to DE 11.9 under the condition 4 had the lowest viscosity.

TABLE 9

| | Dextrin Serving as | | |
|---|---|---|---|
| | Raw Material | | |
| | Method of | | Viscosity |
| | Decomposition | DE | (mPa · s) |
| Condition 1 | α-amylase | 6.0 | 8.5 |
| Condition 2 | α-amylase | 8.0 | 8.5 |
| Condition 3 | α-amylase | 12.0 | 8.6 |
| Condition 4 | Acid | 11.9 | 7.2 |

### Example 8

### Preparation of low DE Branched Dextrin and Properties Thereof

135 g of dextrin with DE=5.2 obtained by decomposing tapioca starch by the known method of decomposition was dissolved in 265 g of a buffer solution (0.1 M phosphate buffer (pH5.5)). And 210 units of α-maltose-generating amylase (Biozyme L: manufactured by Amano Enzyme Inc.) and 10 units of transglucosidase (transglucosidase L “Amano”: manufactured by Amano Enzyme Inc.), that is, ones which were prepared such that the enzyme unit ratio is 21:1, were simultaneously added to initiate a reaction. 15, 30, 45, 90 and 135 minutes later, 50 g was collected each time and kept individually at 95° C. for 15 minutes to terminate the reaction. The resulting samples were individually filtered using diatomaceous earth and desalted using amphoteric ion-exchange resin (manufactured by Organo Corporation) to obtain liquid products of branched dextrin with an osmotic pressure of 53, 61, 73, 101 and 141 mOSMOL/kg, respectively. (DEs thereof were 8.3, 9.5, 10.9, 14.4 and 20.0, respectively.)

For the obtained branched dextrins, an in vitro digestibility test similar to Test Example 1 was carried out. From the results shown in FIG. 12, it was confirmed that the branched dextrins with a DE of not less than 10.9 were, compared with TK-16, less susceptible to digestion by swine pancreatic amylase and rat small intestinal mucosal enzyme and slowly digested. On the other hand, it was confirmed that the branched dextrins with a DE of 9.5 or lower were almost same as TK-16 which is a control.

### Example 9

### Branching Degree Analysis of Branched Dextrin

In order to measure linkage modes of the dextrins produced by the present invention, methylation analysis was carried out in accordance with the method of Ciucanu et al. The results of the methylation analysis of the branched dextrin (DE=20.7) with an osmotic pressure of 140 mOSMOL/kg prepared under the condition 4 of Example 7, the branched dextrin (DE=37.2) with 244 mOSMOL/kg prepared by being allowed to react for 18 hours under the same condition and a dextrin (TK-16: manufactured by Matsutani Chemical Industry Co., Ltd./DE=18) are shown in Table 10. From the results, the branched dextrins prepared by the method of production according to the present invention had, compared with the dextrin, increased percentage of “→4,6)-Glcp-(1→” among “→6)-Glcp-(1→” and “→4,6)-Glcp-(1→” which are glucoses having a branched structure of 1→6 linkage. In addition, “→6)-Glcp-(1→” (glucose binding to the non-reducing terminal by a 1,6 linkage) which was not contained in dextrins at all was newly formed.

TABLE 10

| Linkage Mode of | Branched Dextrin | Branched Dextrin | |
|---|---|---|---|
| Glucose* | 140 mOSMOL/kg | 244 mOSMOL/kg | Dextrin |
| Glcp-(1→(non- | 19.5% | 21.8% | 19.5% |
| reducing terminal) | | | |
| →4)-Glcp-(1→ | 62.7% | 42.9% | 72.7% |
| →6)-Glcp-(1→ | 8.9% | 25.8% | 0.0% |
| →2)-Glcp-(1→ | 0.0% | 0.0% | 0.0% |
| →3)-Glcp-(1→ | 3.2% | 1.5% | 2.0% |
| →4,6)-Glcp-(1→ | 5.2% | 6.8% | 4.8% |
| →3,4)-Glcp-(1→ | 0.6% | 1.1% | 0.9% |
| →2,4)-Glcp-(1→ | 0.0% | 0.0% | 0.0% |
| →2,3)-Glcp-(1→ | 0.0% | 0.0% | 0.0% |
| →3,6)-Glcp-(1→ | 0.0% | 0.0% | 0.0% |

*For example, “→4)-Glcp-(1→” indicates glucose having a glucosidic linkage at 1, 4 position.

### Example 10

### Digestibility Test of Branched Dextrin in Human

Healthy adult males and females (11 subjects) (average age 34.3±1.1 years) were prohibited from eating and drinking beverages except water after 9:00 p.m. a day before the test. 50 g of the branched dextrin with an osmotic pressure of 140 mOSMOL/kg prepared under the condition 4 of Example 7 or a dextrin (Glystar P: manufactured by Matsutani Chemical Industry Co., Ltd./DE=15) was individually dissolved in 200 mL of water to provide a sample, which was taken in by the subjects at 9:00 a.m. on the day of the test. Prior to the intake of the sample, 30, 60, 90 and 120 minutes after the intake, blood was each time collected into a hematocrit tube from a fingertip and serum glucose concentration was measured.

Taking a blood glucose value prior to the intake of the sample as 0, an amount of rise in blood glucose values after the intake is shown in FIG. 13 and an area under the curve (AUC) thereof is shown in FIG. 14. The amount of rise in the blood glucose values after the intake of the branched dextrin tended to be lower than that after the intake of the dextrin. The AUC for the branched dextrin was significantly lower than that of the dextrin by a t-test. With the AUC of the dextrin taken as 100, AUC of the branched dextrin, that is, its glycemic index (GI) was 78. From this, it was proven that the branched dextrin was digested and absorbed in human more slowly than the dextrin. From this result, the branched dextrin was thought to be applicable to foods requiring low GI (such as nutritional supplement products for diabetic patients, diet food, energy supplying drinks or nutritional supplement food products). Also, since digested and absorbed more slowly, the branched dextrin was thought to be applicable to energy-lasting type food products (such as diet food or sports drinks).

### Example 11

### Test for Stick-to-the-Ribs Feeling

The subjects were 10 of healthy adult males and females (average age 33.8±1.1 years). They were prohibited from eating and drinking beverages except water after 9:00 p.m. a day before the test. On the day of the test, the subjects were, without having breakfast, gathered in a test laboratory where they are able to be at rest. 50 g of the branched dextrin with an osmotic pressure of 140 mOSMOL/kg prepared under the condition 4 of Example 7 or a dextrin (Glystar P: manufactured by Matsutani Chemical Industry Co., Ltd./DE=15) was individually dissolved in 200 mL of water and were taken in by the subjects at 9:00 a.m. on the day of the test. Prior to the intake and, after the intake, for 3 hours at 30 minute interval, evaluation was performed by rating on a 5-point scale as follows:

Score 5: Did not have a feeling of hunger

Score 4: Had a slight feeling of hunger

Score 3: Had a feeling of hunger

Score 2: Had a strong feeling of hunger

Score 1: Could not bear hunger

The results of evaluation of the feeling of hunger are shown in FIG. 15. From FIG. 15, the results indicating that the branched dextrin caused a less feeling of hunger for a longer period of time and stuck to the ribs better than the dextrin were obtained. From this, the branched dextrin can be applied to food requiring a stick-to-the-ribs feeling and energy-lasting effect (such as nutritional supplement products for diabetic patients, diet food, energy supplying drinks or nutritional supplement food products).

### Example 12

### Preparation of Enteral Nutrition Product

An enteral nutrition product containing the branched dextrin of Example 2 with an osmotic pressure of 105 mOSMOL/kg was prepared in accordance with the prescription of Table 11 and a good product was obtained.

TABLE 11

| Name of Raw Material | Formulation (Parts by Weight) |
|---|---|
| Branched dextrin | 10.00 |
| Sugar | 5.00 |
| Casein sodium | 2.00 |
| Milk protein | 1.50 |
| Corn oil | 1.50 |
| Safflower oil | 1.50 |
| Neutral fatty acid triglyceride | 0.50 |
| Sodium citrate | 0.25 |
| Essence | 0.20 |
| Whey mineral | 0.20 |
| Potassium chloride | 0.15 |
| Magnesium chloride | 0.15 |
| Egg white | 0.10 |
| Soybean peptide | 0.10 |
| Lecithin | 0.05 |
| Vitamin C | 0.006 |
| Methionine | 0.005 |
| Vitamin E | 0.005 |
| Sodium ferrous citrate | 0.0075 |
| Niacin | 0.0013 |
| Calcium pantothenate | 0.0006 |
| Vitamin B6 | 0.00013 |
| Vitamin B2 | 0.00011 |
| Vitamin B1 | 0.00008 |
| Vitamin A | 250 (IU) |
| Folic acid | 0.000015 |
| Vitamin D | 12 (IU) |
| Vitamin B12 | 0.00000012 |
| Water | Filled to obtain an equivalent of |
| | 100 parts by weight |

### Example 13

### Preparation of Meal Substitute Drink

A drink for substituting meal containing the branched dextrin of Example 2 with an osmotic pressure of 105 mOSMOL/kg was prepared in accordance with the prescription of Table 12 and a good product was obtained.

TABLE 12

| Name of Raw Material | Formulation (Parts by Weight) |
|---|---|
| Branched dextrin | 10.0 |
| Sugar | 5.0 |
| Milk protein | 5.0 |
| Rice oil*1 | 1.0 |
| Cocoa powder | 1.0 |
| Microcrystalline cellulose*2 | 0.5 |
| Emulsifier*3 | 0.05 |
| Potassium chloride | 0.1 |
| Vitamin mix*4 | 0.1 |
| Flavor*5 | 0.1 |
| Water | Filled to obtain an equivalent of |
| | 100 parts by weight |

*1Manufactured by Tsuno Food Industrial Co.
*2Manufactured by Asahi Kasei Corporation (Avicel CL-611S)
*3Manufactured by Mitsubishi-Kagaku Foods Corporation (Sugar ester P-1670)
*4Manufactured by Takeda Pharmaceutical Co., Ltd. (New Bairichi WS-7L)
*5Manufactured by Takata Koryo Co., Ltd. (Custard vanilla essence T-484)

### Example 14

### Preparation of Energy Drinks

An energy drink containing the branched dextrin of Example 2 with an osmotic pressure of 105 mOSMOL/kg was prepared in accordance with the prescription of Table 13 and a good product was obtained.

TABLE 13

| Name of Raw Material | Formulation (Parts by Weight) |
|---|---|
| Branched dextrin | 20.0 |
| Fructose | 3.0 |
| Citric acid | 0.13 |
| Sodium citrate | 0.05 |
| Vitamin C | 0.05 |
| Caffeine | 0.01 |
| Sodium chloride | 0.01 |
| Potassium chloride | 0.01 |
| Flavor* | 0.11 |
| Water | Filled to obtain an equivalent of |
| | 100 parts by weight |

*Manufactured by Takata Koryo Co., Ltd. (grapefruit essence #2261)

### Example 15

### Preparation of Jelly

A jelly containing the branched dextrin of Example 2 with an osmotic pressure of 105 mOSMOL/kg was prepared in accordance with the prescription of Table 14 and a good product was obtained.

TABLE 14

| Name of Raw Material | Formulation (Parts by Weight) |
|---|---|
| Branched dextrin | 22.0 |
| Fructose | 3.0 |
| Polysaccharide thickener*1 | 0.16 |
| Vitamin C | 0.1 |
| Citric acid | 0.08 |
| Calcium lactate | 0.06 |
| Sodium chloride | 0.03 |
| Potassium chloride | 0.02 |
| Sodium glutamate | 0.005 |
| ⅕ white grape fruit juice*2 | 0.3 |
| Flavor*3 | 0.1 |
| Water | Filled to obtain an equivalent of |
| | 100 parts by weight |

*1Manufactured by Dainippon Sumitomo Pharma Co., Ltd. (Kelcogel)
*2Manufactured by Oyama Company Limited
*3Manufactured by Takata Koryo Co., Ltd. (Muscat essence #50631)

### BRIEF DESCRIPTION OF THE DRAWINGS

FIG. 1 shows the results of the in vitro digestibility test of the branched dextrin obtained under the condition that the unit ratio of β-amylase and transglucosidase is 2:1.

FIG. 2 shows the results of the in vitro digestibility test of the branched dextrin obtained under the condition that the unit ratio of β-amylase and transglucosidase is 21:1.

FIG. 3 shows the results of the in vitro digestibility test of the branched dextrin obtained under the condition that the unit ratio of β-amylase and transglucosidase is 44:1.

FIG. 4 shows the results of the in vitro digestibility test of the branched dextrin obtained under the condition of transglucosidase alone.

FIG. 5 shows the results of the in vitro digestibility test of the branched dextrin obtained under the condition that the unit ratio of β-amylase and transglucosidase is 132:1.

FIG. 6 shows the results of the in vitro digestibility test of the branched dextrin obtained under the condition that the unit ratio of β-amylase and transglucosidase is 330:1.

FIG. 7 shows the results of the in vitro digestibility test of the branched dextrin obtained under the condition that the unit ratio of β-amylase and transglucosidase is 660:1.

FIG. 8 shows the results of the in vitro digestibility test of the branched dextrin obtained by varying the substrate concentration.

FIG. 9 shows the results of the in vitro digestibility test of the branched dextrin obtained by varying the concentration of the added enzyme.

FIG. 10 shows the results of the in vitro digestibility test of the branched dextrin obtained by varying the type of maltose-generating amylase.

FIG. 11 shows the results of the in vitro digestibility test of the branched dextrin obtained by varying DE of the dextrin serving as the substrate.

FIG. 12 shows the results of the in vitro digestibility test of the branched dextrin having low DE.

FIG. 13 shows, with a blood glucose value prior to intake of a sample taken as 0, an amount of a rise in the blood glucose value after the intake.

FIG. 14 shows an area under the curve (AUC) of FIG. 13.

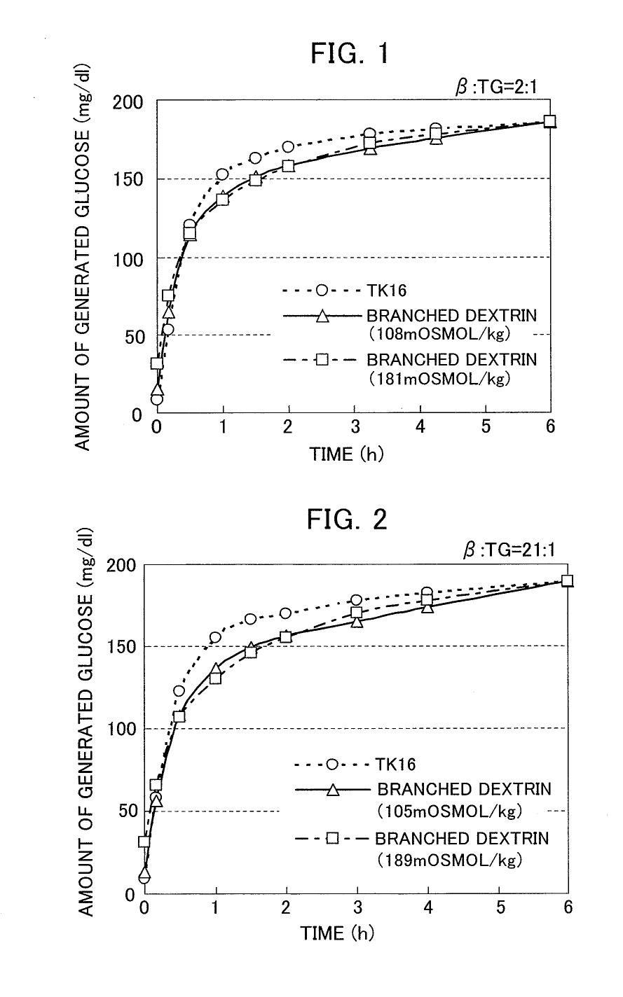

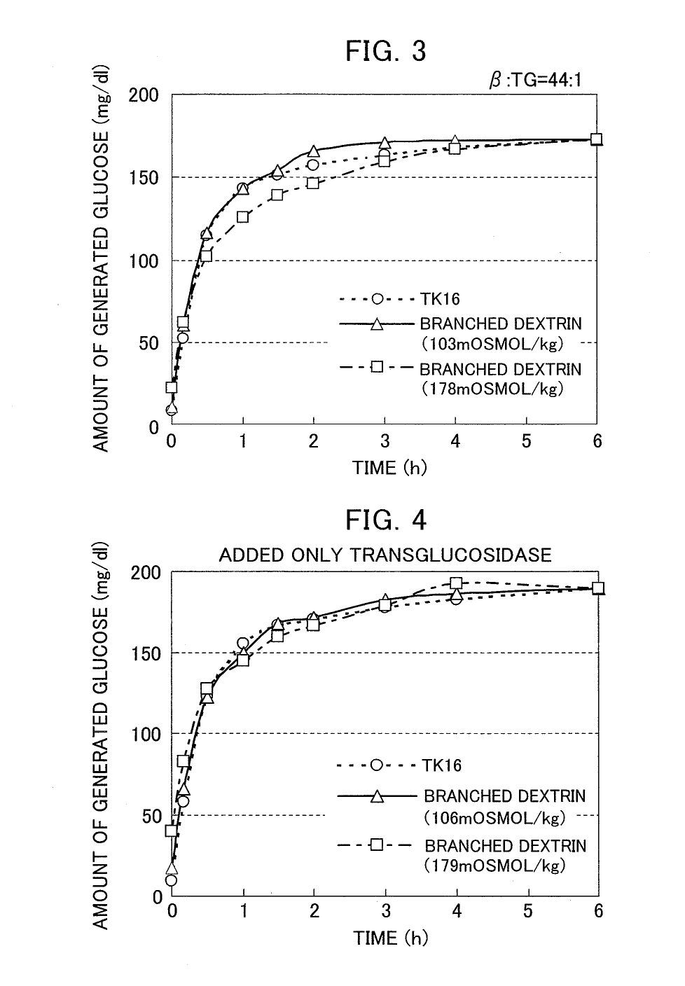

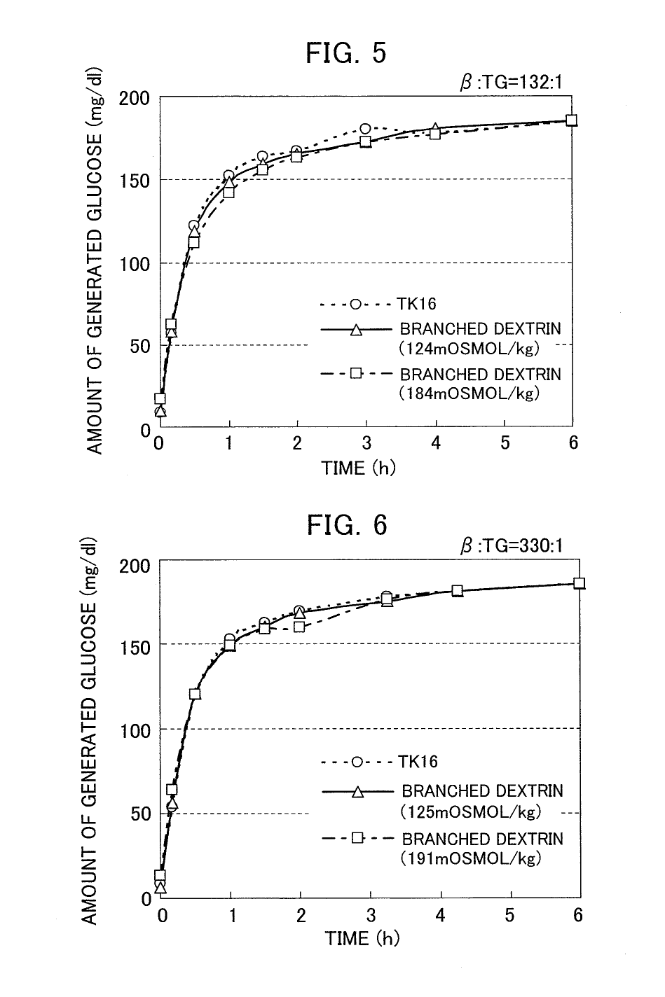

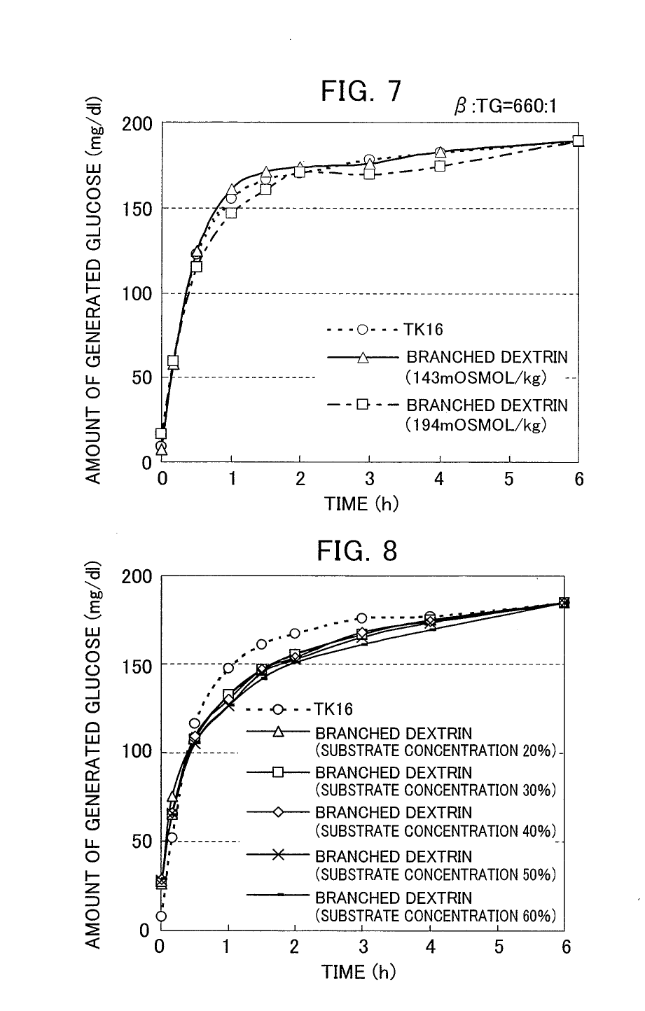

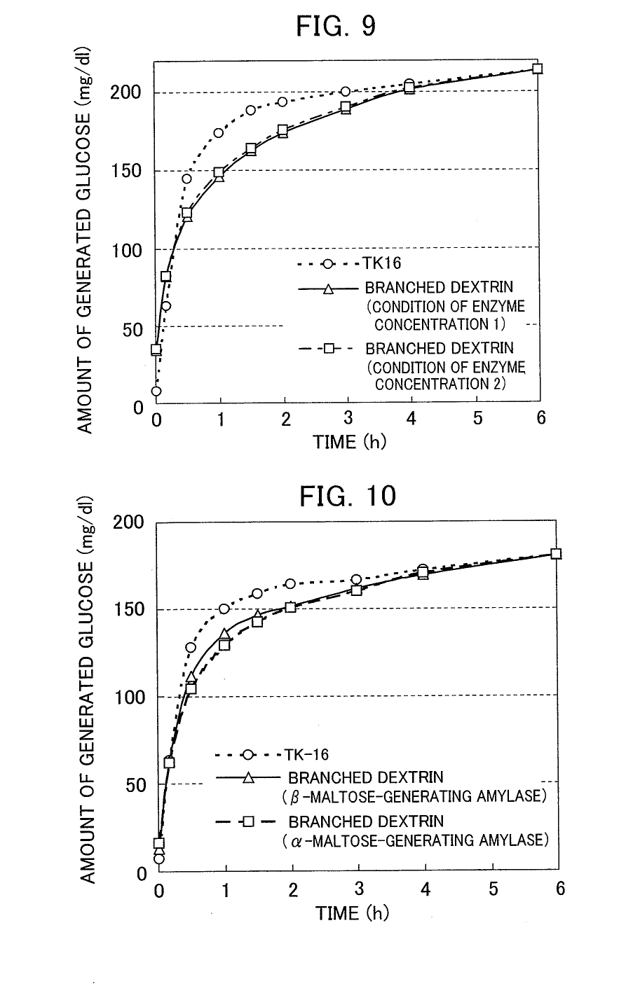

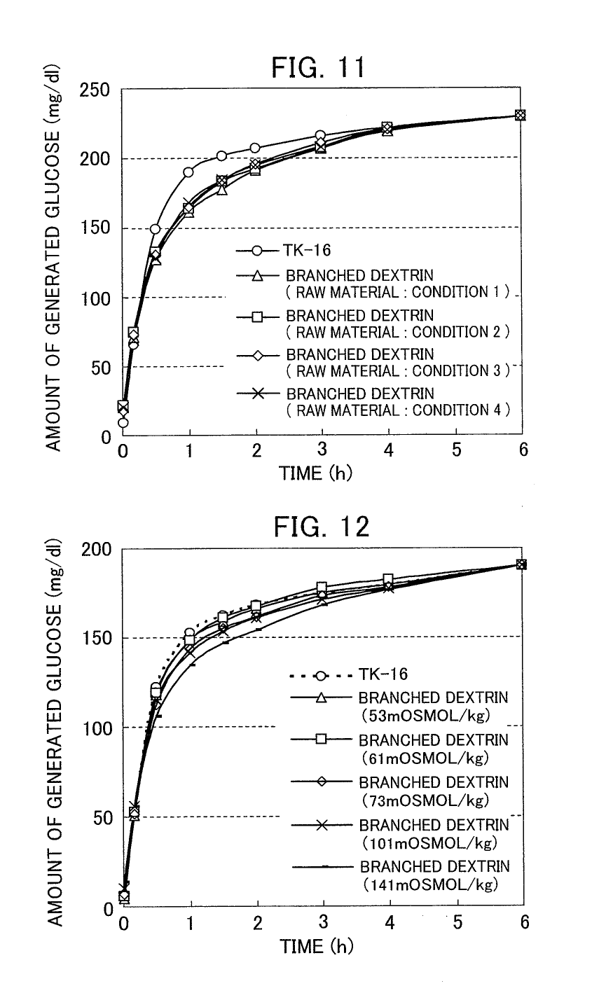

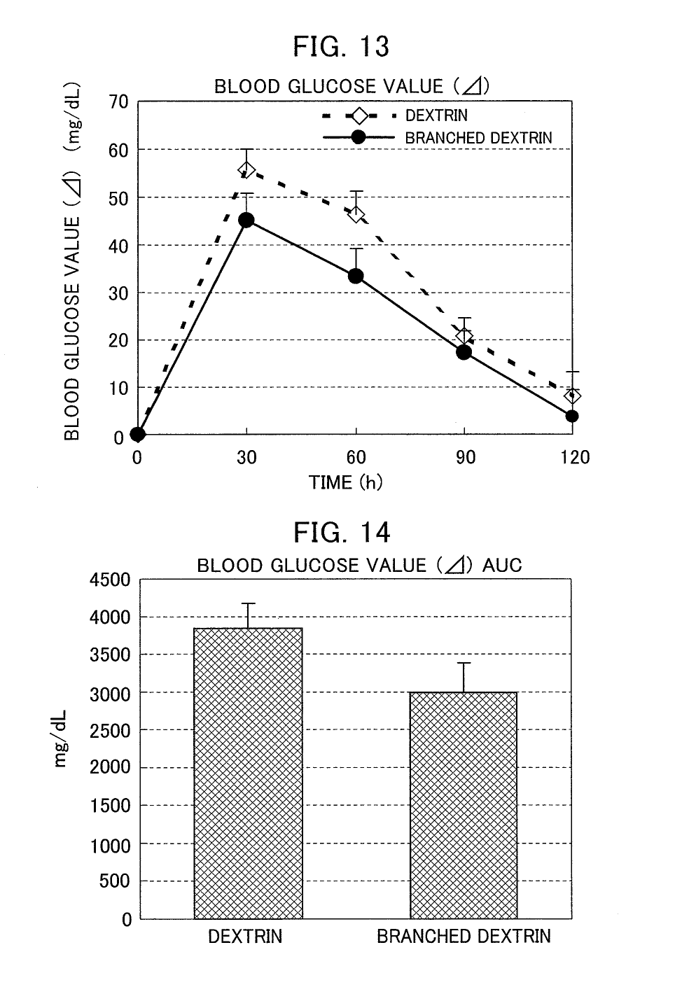

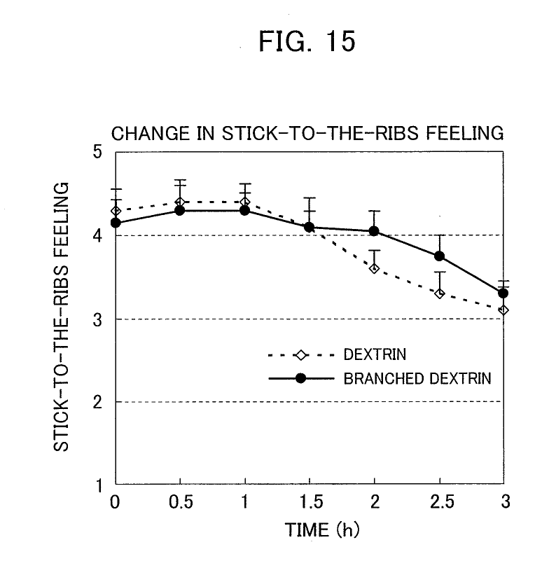

FIG. 13 shows the results of the evaluation for a feeling of hunger in Example 10.

1. A branched dextrin having a structure wherein glucose or isomalto oligosaccharide is linked to a non-reducing terminal of a dextrin through an α-1,6 glucosidic bond and having a DE of 10 to 52.

2. The branched dextrin according to claim 1, wherein an osmotic pressure of 10% by weight aqueous solution thereof is 70 to 300 mOSMOL/kg.

3. A food product and beverage containing said branched dextrin according to claim 1.

4. The food product and beverage according to claim 3 which is a diet food, energy supplying drink, energy lasting food product or nutritional supplement food product.

5. A nutritional supplement product containing said branched dextrin according to claim 1.

6. An energy lasting product containing said branched dextrin according to claim 1.

7. An agent causing a stick-to-the-ribs feeling containing said branched dextrin according to claim 1.

8. A method for preparing the branched dextrin according to claim 1, by allowing maltose-generating amylase and transglucosidase to act on an aqueous dextrin solution, comprising a step of adjusting enzyme unit ratio of said maltose-generating amylase and said transglucosidase to 2:1 to 44:1 and a step of allowing the enzymes to act on the aqueous dextrin solution.

9. The method for producing the branched dextrin according to claim 8, wherein said maltose-generating amylase is an α-maltose-generating amylase.

10. The method for producing the branched dextrin according to claim 8, wherein the DE of said dextrin is 2 to 20.

11. The method for producing the branched dextrin according to claim 8, wherein a concentration of said dextrin is 20 to 50% by weight.

12. The method for producing the branched dextrin according to claim 8, wherein said dextrin is an acid hydrolysate of a starch.
